(19) United States
(12) Patent Application Publication
(10) Pub. No.: US 2012/0177150 A1
(43) Pub. Date: Jul. 12, 2012

(54) RECEIVER

(75) Inventors: Hui-Hsien LIU, Taipei (TW); Tsung-Hsien Lin, Taipei (TW); Yao-Hong Liu, Taipei (TW)

(73) Assignee: Tsung-Hsien Lin, Taipei (TW)

(21) Appl. No.: 13/089,560

(22) Filed: Apr. 19, 2011

(30) Foreign Application Priority Data
Jan. 12, 2011 (TW) 100101112

(51) Int. Cl. H04L 27/14

(52) U.S. Cl. 375/334

(57) ABSTRACT

A receiver comprises an input-stage circuit, a filter circuit, an output-stage circuit and a digital control oscillator. The input-stage circuit has a mixer configured for mixing the GFSK signal and a feedback signal to generate an input-stage current signal to the filter circuit. Then the filter circuit filters the input-stage current signal, and converts it into a voltage signal. The output-stage circuit is coupled to the filter circuit, for converting the voltage signal into a digital output data. In addition, the digital control oscillator is coupled to the output-stage circuit, for outputting the feedback signal based on the digital output data.

### FIELD OF THE INVENTION

The present invention relates to a receiver, and more particularly to a receiver for receiving Gauss Frequency Shift Keying (GFSK) signals.

### BACKGROUND OF THE INVENTION

FIG. 1 is a system block schematic view of a conventional GFSK receiver. Referring to FIG. 1, the conventional GFSK receiver 100 comprises a phase frequency detector (PFD) 102, a charge pump 104, a filter 106, a thermometer code generator 108, an analog-digital converter (DAC) 110 and a voltage controlled oscillator (VCO) 112. The PFD 102 is configured for receiving a GFSK signal GFSK_IN, and comparing it with a feedback signal FB to generate a comparison result. The comparison result will be transferred to the charge pump 104, to generate a voltage signal V1. Then the filter 106 filters the voltage signal V1 to eliminate noise, and transfers a corresponding filtered voltage signal V1′ to the thermometer code generator 108. Thus, the thermometer code generator 108 generates a digital output data DATA_OUT based on the voltage signal V1′.

An output terminal of the thermometer code generator 108 is coupled to the DAC 110. Thus the DAC 110 outputs a control voltage signal V_{CTRL} to VCO 112 based on the digital output data DATA_OUT. At the moment, the VCO 112 generates an oscillating voltage signal as the feedback signal FB to the PFD 102 based on the control voltage signal V_{CTRL}.

However, since the gain of the VCO 112 is prone to be influenced by the change of the manufacture procedure, the voltage and the temperature, the feedback signal FB is unstable. In addition, the control voltage signal V_{CTRL} is also prone to be influenced by the noise of the DAC 110.

In addition, the conventional receiver 100 sometimes needs a mixer before the PFD 102. Thus, it will increase the size of the receiver 100.

### SUMMARY OF THE INVENTION

Therefore, the present invention relates to a receiver configured for receiving and processing a GFSK signal.

A receiver in accordance with an exemplary embodiment of the present invention, comprises an input-stage circuit, a filter circuit, an output-stage circuit and a digital control oscillator. The input-stage circuit has a mixer configured for mixing the GFSK signal and a feedback signal to generate an input-stage current signal to the filter circuit. Then the filter circuit filters the input-stage current signal, and converts it into a voltage signal. The output-stage circuit is coupled to the filter circuit, for converting the voltage signal into a digital output data. In addition, the digital control oscillator is coupled to the output-stage circuit, for outputting the feedback signal based on the digital output data.

In an exemplary embodiment of the present invention, the digital control oscillator comprises a modulator, a multi-phase locked loop (PLL) and a phase switcher. The modulator is coupled to the output-stage circuit, for generating a modulation signal to the phase switcher based on the digital output data. In addition, the PLL is configured for outputting a plurality of phase signals to the phase switcher. Therefore, the phase switcher can generate the feedback signal based on the phase signals and the modulation signal.

The present invention employs the digital control oscillator to generate the feedback signal, thus it will not be influenced by the manufacturing processes and the noise, and the present invention will not decrease the quality of the feedback signal.

### BRIEF DESCRIPTION OF THE DRAWINGS

The above objects and advantages of the present invention will become more readily apparent to those ordinarily skilled in the art after reviewing the following detailed description and accompanying drawings, in which:

FIG. 1 is a system block schematic view of a conventional GFSK receiver.

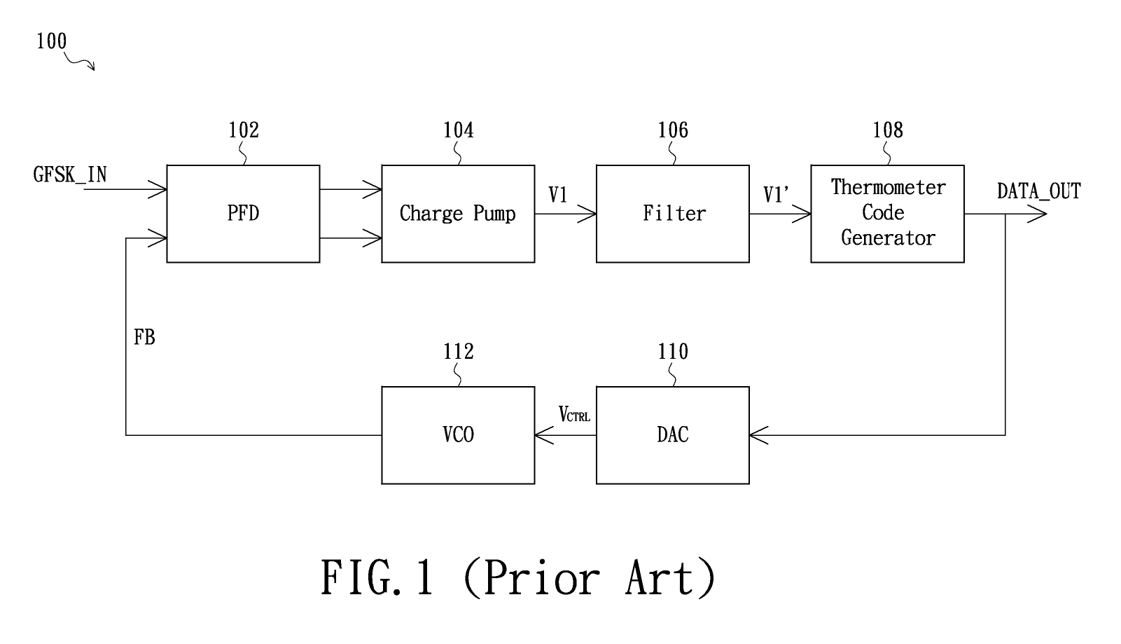

FIG. 2 is a system block schematic view of a receiver in accordance with an exemplary embodiment of the present invention.

FIG. 3 is a circuit block schematic view of an input-stage circuit in accordance with an exemplary embodiment of the present invention.

FIG. 4 is a circuit block schematic view of a filter circuit in accordance with an exemplary embodiment of the present invention.

FIG. 5 is a circuit block schematic view of an output-stage circuit in accordance with an exemplary embodiment of the present invention.

FIG. 6 is circuit block schematic view of a digital control oscillator in accordance with an exemplary embodiment of the present invention.

FIG. 7 is a circuit block schematic view of a phase switcher in accordance with an exemplary embodiment of the present invention.

FIG. 8 is a logic architecture view of a phase-state accumulator in accordance with an exemplary embodiment of the present invention.

FIG. 9 is a signal time-sequence view of a phase switcher in accordance with an exemplary embodiment of the present invention.

### DETAILED DESCRIPTION OF PREFERRED EMBODIMENTS

The present invention will now be described more specifically with reference to the following embodiments. It is to be noted that the following descriptions of preferred embodiments of this invention are presented herein for purpose of illustration and description only. It is not intended to be exhaustive or to be limited to the precise form disclosed.

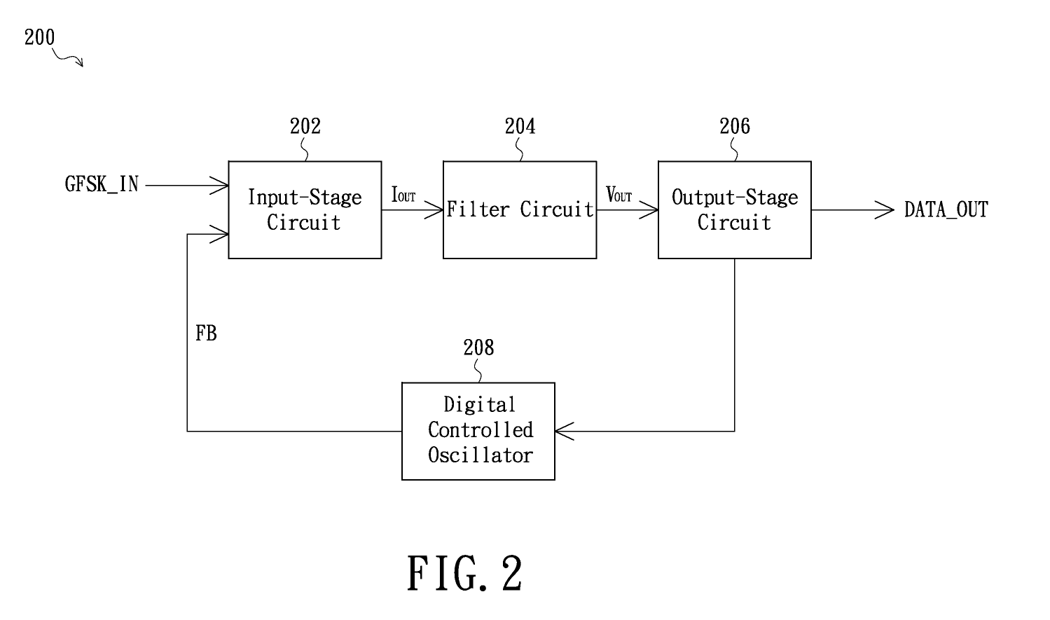

FIG. 2 is a system block schematic view of a receiver in accordance with an exemplary embodiment of the present invention. Referring to FIG. 2, the receiver 200 of the exemplary embodiment comprises an input-stage circuit 202, a filter circuit 204, an output-stage circuit 206 and a digital control oscillator 208. The input-stage circuit 202 is coupled to the filter circuit 204, and the filter circuit 204 is further coupled to the output-stage circuit 206. In the exemplary embodiment, an output terminal of the output-stage circuit 206 is used as an output terminal of the receiver 200. In addition, the output terminal of the output-stage circuit 206 is further coupled to the digital control oscillator 208, and an output terminal of the digital control oscillator 208 is coupled to an input terminal of the input-stage circuit 202.

In the exemplary embodiment, the input-stage circuit 202 receives a GFSK signal GFSK_IN, mixes it with a feedback signal FB, and outputs an input-stage current signal I_{OUT} to the filter circuit 204. At the moment, the filter circuit 204 filters the input-stage current signal I_{OUT}, and converts it into a voltage signal V_{OUT} to the output-stage circuit 206. Therefore, the output-stage circuit 206 generates a digital output data DATA_OUT based on the voltage signal V_{OUT}. In addition, the digital output data DATA_OUT will be transferred to the digital control oscillator 208. Therefore, the digital control oscillator 208 generates the feedback signal FB based on the digital output data DATA_OUT, to another input terminal of the input-stage circuit 202.

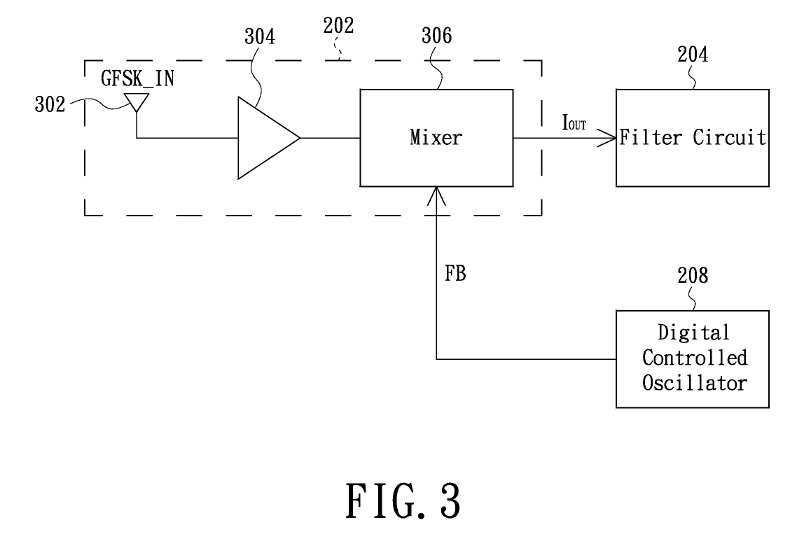

FIG. 3 is a circuit block schematic view of an input-stage circuit in accordance with an exemplary embodiment of the present invention. Referring to FIG. 3, the input-stage circuit 202 of the exemplary embodiment comprises an antenna 302, an amplifier 304 and a mixer 306. The antenna 302 may receive the GFSK signal GFSK_IN through a wireless transmitting interface, and transfers it to the amplifier 304. The amplifier 304 has a predetermined gain value configured for amplifying the GFSK signal GFSK_IN, and then transfers it to the mixer 306.

The mixer 306 is coupled to the filter circuit 204 and the digital control oscillator 208. Therefore, the mixer 306 can mixes the GFSK signal GFSK_IN and the feedback signal FB, to output the input-stage current signal I_{OUT} to the filter circuit 204.

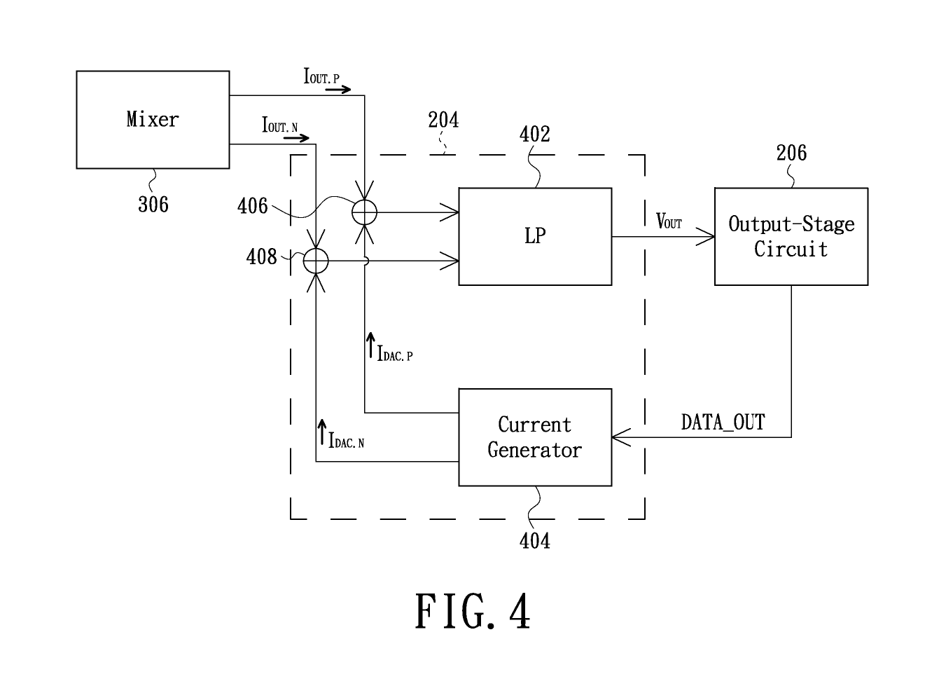

FIG. 4 is a circuit block schematic view of a filter circuit in accordance with an exemplary embodiment of the present invention. Referring to FIG. 4, the filter circuit 204 of the exemplary embodiment comprises a low-pass (LP) filter 402 configured for filtering the input-stage current signals I_{OUT,P} and I_{OUT,N} outputted from the mixer 306, to eliminate the noise with the high frequency. In addition, the LP filter 402 further converts the input-stage current signals I_{OUT,P} and I_{OUT,N} into the voltage signal V_{OUT}, and transfers it to the output-stage circuit 206 for being further processed.

In the exemplary embodiment, for eliminating the noise generated by the output-stage circuit 206, the filter circuit 204 further comprises a current generator 404, and adders 408 and 406. The current generator 404 is coupled to the output-stage circuit 206, for converting the digital output data DATA_OUT into analog current signals I_{DAC,P} and I_{DAC,N}. The adders 406 and 408 are coupled to the mixer 306 and the current generator 404 respectively, to add the current signals I_{OUT,P} and I_{DAC,P}, and add the current signals I_{OUT,N} and I_{DAC,N}. Therefore, it can shaping the noise with the low frequency. Then, the adders 406 and 408 transfer the added results thereof to the LP filter 402, for generating the voltage signal V_{OUT}. Therefore, the voltage signal V_{OUT} comprises the shaping noise with the low frequency, which will be processed later.

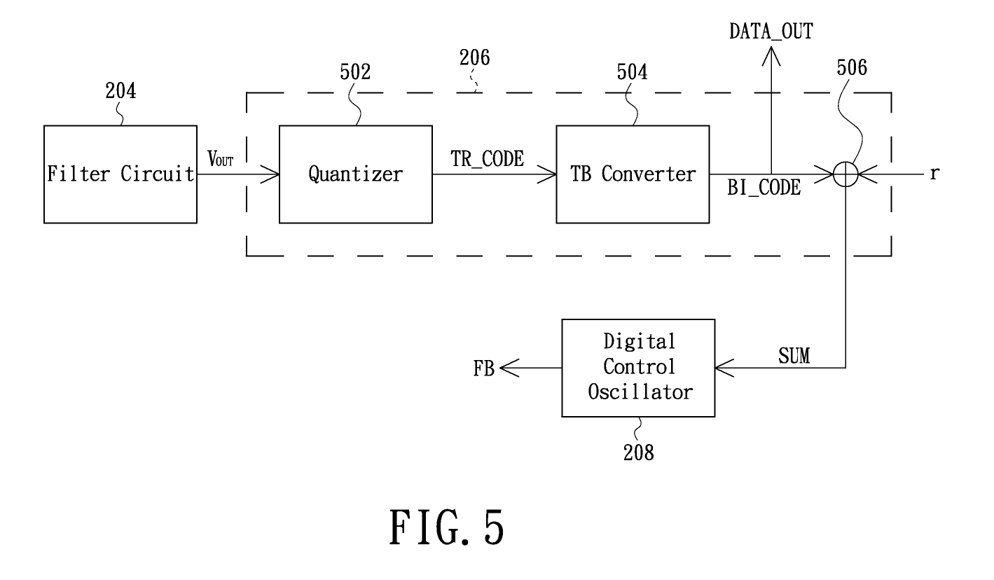

FIG. 5 is a circuit block schematic view of an output-stage circuit in accordance with an exemplary embodiment of the present invention. Referring to FIG. 5, the output-stage circuit 206 of the exemplary embodiment, at least comprises a quantizer 502, which may be coupled to the filter circuit 204. Therefore, the quantizer 502 may generate a thermometer code TR_CODE based on the voltage signal V_{OUT}. Thus, the output-stage circuit 206 can generate the digital output data DATA_OUT based on the thermometer code TR_CODE.

In some exemplary embodiments, the output-stage circuit 206 may further comprises a TB converter 504, which is coupled to the quantizer 502. The TB converter 504 is configured for converting the thermometer code TR_CODE into a binary-bit code BI_CODE, and using it as the digital output data DATA_OUT. In some exemplary embodiments, the digital output data DATA_OUT may be a binary-bit code BICODE with 3 bits.

In addition, the output-stage circuit 206 may further comprise an adder 506. The adder 506 may be coupled to the TB converter 504 for receiving the binary-bit code BI_CODE, and adding the binary-bit code BI_CODE with a predetermined value r to generate a sum value SUM. The predetermined value r and the sum value SUM may be binary-bit codes with 13 bits. Then, the sum value SUM is transferred to the digital control oscillator 208 for determining a centre oscillating frequency. In other words, the predetermined value r can determine the oscillating frequency of the digital control oscillator 208.

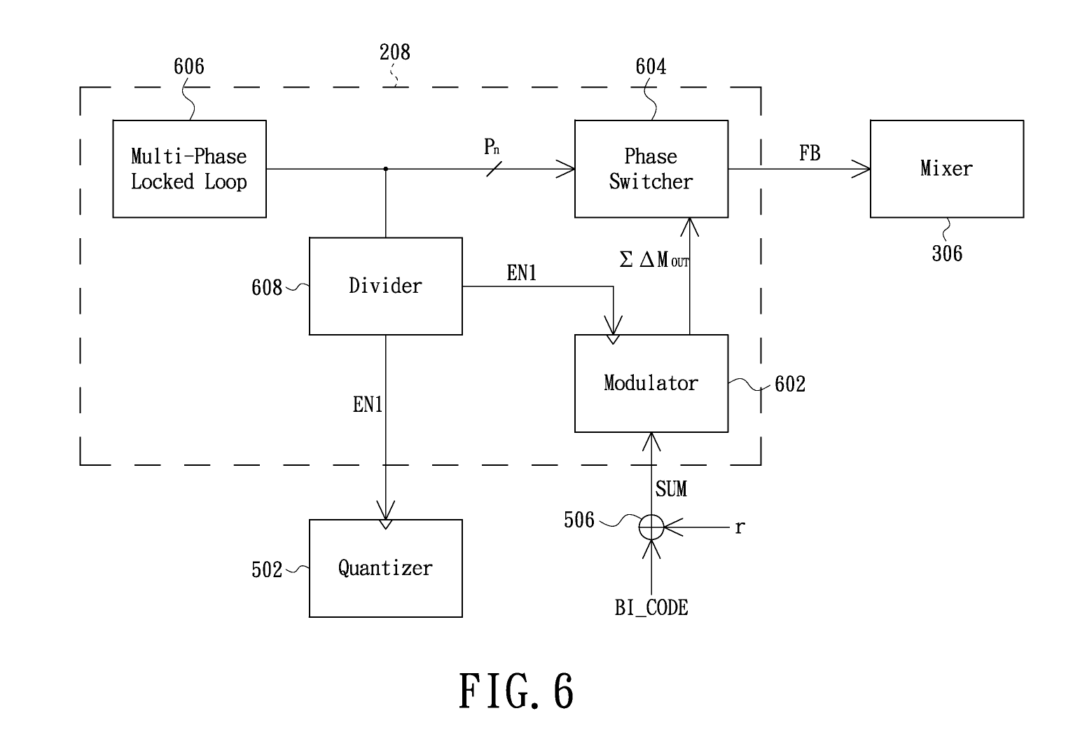

FIG. 6 is circuit block schematic view of a digital control oscillator in accordance with an exemplary embodiment of the present invention. Referring to FIG. 6, the digital control oscillator 208 of the exemplary embodiment comprises a modulator 602, a phase switcher 604 and a multi-phase locked loop 606. The modulator 602 is coupled to the adder 506 and the phase switcher 604, and the phase switcher 604 is coupled to the mixer 306 and the PLL 606.

In the exemplary embodiment, the modulator 602 is a sigma-delta modulator (or called ΣΔ Modulator), which may perform a sigma-delta modulation for the sum value SUM, to generate a modulated output signal ΣΔM_{OUT} to the phase switcher 604. Therefore, the modulator 602 can efficiently eliminate the noise with the low frequency of the system, based on the shaping result of the noise with the low frequency.

In addition, the multi-phase locked loop 606 is configured for generating a plurality of phase signals Pn to the phase switcher 604. Therefore, the phase switcher 604 outputs the feedback signal FB to the mixer 306 based on the modulation signal ΣΔM^{OUT} and one of the phase signals Pn.

In the exemplary embodiment, the phase signals Pn generated by the multi-phase locked loop 606 comprises a phase signal P0 with 0 degree, a phase signal P45 with 45 degrees, a phase signal P90 with 90 degrees, a phase signal P180 with 180 degrees, a phase signal P225 with 225 degrees, a phase signal P270 with 270 degrees, and a phase signal P315 with 315 degrees.

In addition, the digital control oscillator 208 may further comprises a divider 608 coupled to the multi-phase locked loop 606, the modulator 602 and the quantizer 502. In the exemplary embodiment, the divider 608 will divide the output of the multi-phase locked loop 606 by a predetermined value, such as 2, to generate an enable signal EN1. The enable signal EN1 will be transferred to the modulator 602 and the quantizer 502 respectively, to enable them respectively.

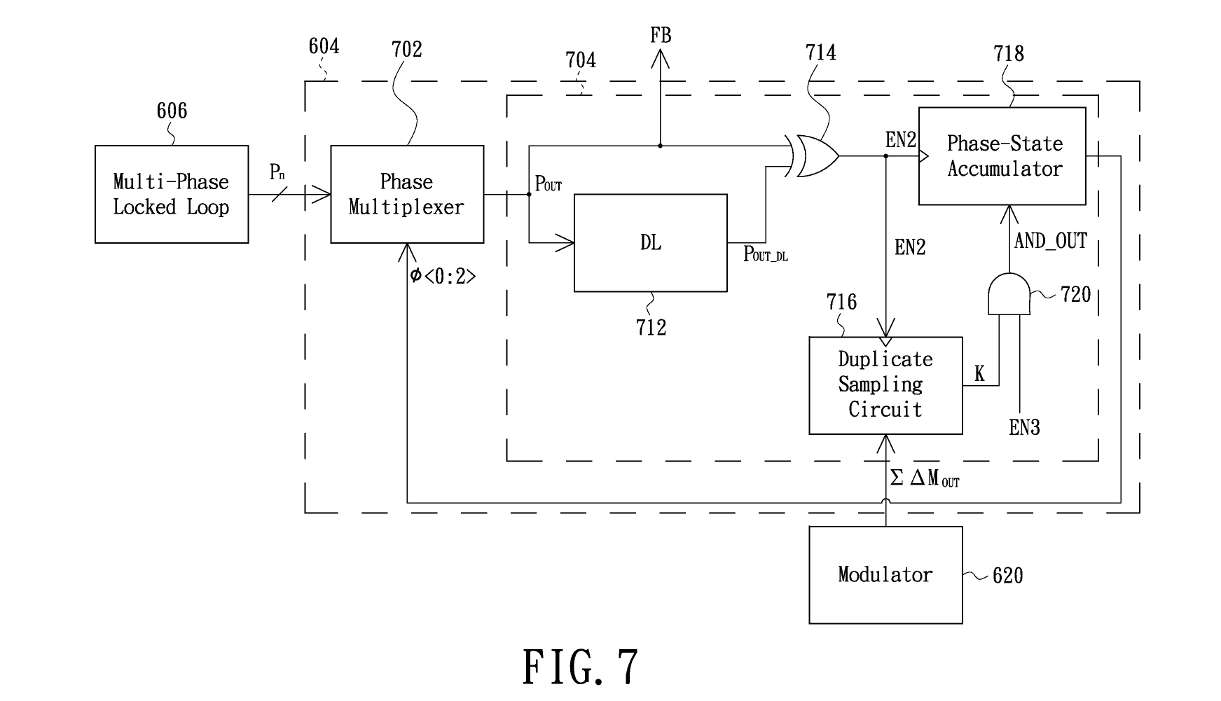

FIG. 7 is a circuit block schematic view of a phase switcher in accordance with an exemplary embodiment of the present invention. Referring to FIG. 7, the phase switcher 604 of the exemplary embodiment comprises a phase multiplexer 702 and a phase controller 704. The phase multiplexer 702 is coupled to the phase controller 704, and is coupled to the multi-phase locked loop 606 to receive the plurality of phase signals Pn. In addition, the phase controller 704 is coupled to the modulator 602 for receiving the modulation signal ΣΔM_{OUT}.

Referring to FIG. 7 continuously, the phase multiplexer 702 may select one of the phase signals Pn as a phase output signal POUT to the phase controller 704 based on a selection instruction φ<0:2>. An output terminal of the phase multiplexer 702 is coupled to an output terminal of the phase switcher 604. Therefore, the phase output signal P_{OUT} is used as the feedback signal FB. In addition, the phase controller 704 generates the selection instruction φ<0:2> based on the phase output signal P_{OUT} and the modulation signal ΣΔM_{OUT}. In the exemplary embodiment, the selection instruction is a binary-bit code with 3 bits. However, the present invention is not limited in this.

In addition, the phase controller 704 comprises a delayer 712, an Exclusive-OR (XOR) gate 714, a duplicate sampling circuit 716, a phase-state accumulator 718 and an AND gate 720. The delayer 712 is coupled to the phase multiplexer 792 for receiving the phase output signal P_{OUT}, and delaying it by a predetermined time to output a delayed phase output signal P_{OUT}_{_{—}}_{DL}. In addition, a first input terminal and a second input terminal of the XOR gate 714 are coupled to the phase multiplexer 702 and the delayer 712 respectively, to output an XOR gate signal based on the phase output signal P_{OUT} and the delayed phase output signal P_{OUT}_{_{—}}_{DL}, that is an enable signal EN2. The enable signal EN2 will be transferred to the duplicate sampling circuit 716 and the phase-state accumulator 718, for enabling them respectively.

In the exemplary embodiment, the duplicate sampling circuit 716 may be performed by a D-type flip-flop. Therefore, when the duplicate sampling circuit 716 is enabled, it generates a control signal K based on the modulation signal ΣΔM_{OUT}, and transfers the control signal K to a first input terminal of the AND gate 720. In addition, a second input terminal of the AND gate 720 is configured for receiving an enable signal EN3. Therefore, when the control signal K and the enable signal EN3 are simultaneously in a logic 1 state, the AND gate 720 will output a high AND signal AND_OUT to the phase-state accumulator 718. At the moment, the phase-state accumulator 718 generates a selection instruction to φ<0:2> the phase multiplexer 702.

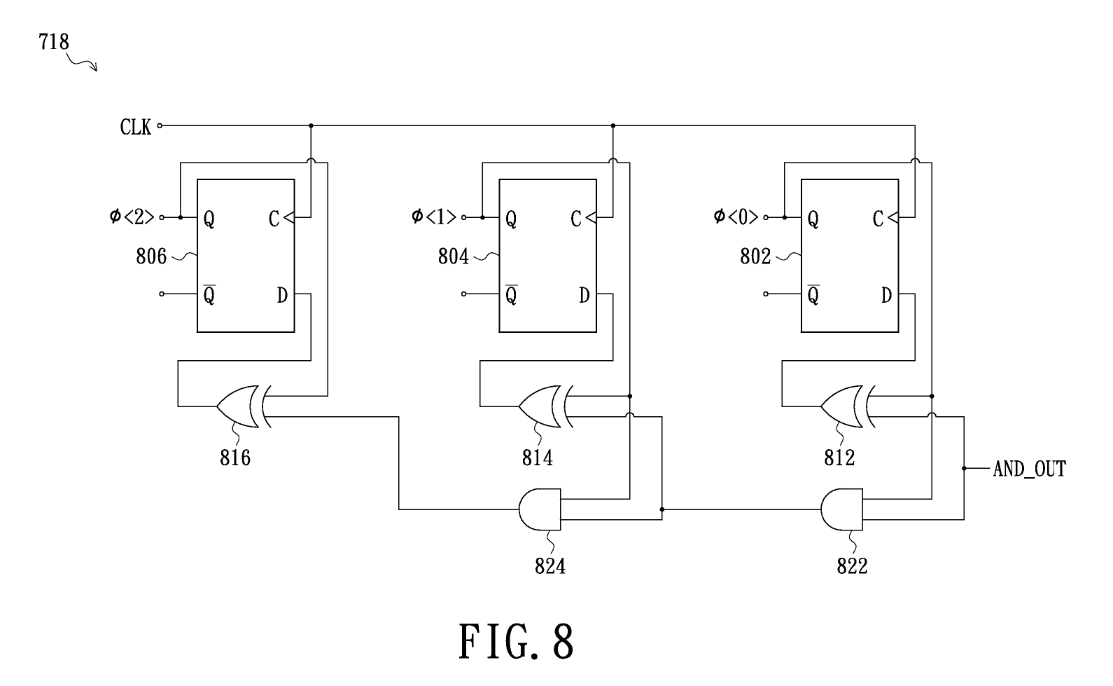

FIG. 8 is a logic architecture view of a phase-state accumulator in accordance with an exemplary embodiment of the present invention. Referring to FIG. 8, in the exemplary embodiment, the phase-state accumulator 718 comprises a plurality of D-type flip-flops, such as 802, 804 and 806. Each of the D-type flip-flops 802, 804 and 806 has an enable terminal C, an input terminal D, a positive output terminal Q and a negative output terminal Q̅. All of the enable terminals C are coupled to a clock signals CLK. The negative output terminal Q̅ of each of the D-type flip-flops 802, 804 and 806 is floating, and the positive output terminal Q thereof is configured for outputting a corresponding one of a plurality of bits of the selection instruction φ<0:2>. For example, the D-type flip-flops 802, 804 and 806 output a low bit, a middle bit and a high bit of the selection instruction φ<0:2> from the positive output terminals thereof respectively.

In addition, the phase-state accumulator 718 further comprises a plurality of Exclusive-OR (XOR) gates, such as 812, 814 and 816, and a plurality of AND gates, such as 822 and 824. First input terminals and second input terminals of the XOR gate 812 and the AND gate 822, or the XOR gate 814 and the AND gate 824, are coupled together with each other. In addition, the positive output terminal Q and the input terminal D of the D-type flip-flop 802 are coupled to the output terminal and the first input terminal of the XOR gate 812 respectively. The positive output terminal Q and the input terminal D of the D-type flip-flop 802 are coupled to the output terminal and the first input terminal of the XOR gate 816. Furthermore, the second input terminal of the XOR gate 812 is configured for receiving the AND signal AND_OUT, the second input terminal of the XOR gate 814 is coupled to the output terminal of the AND gate 822, and the second input terminal of the XOR gate 816 is coupled to the output terminal of the AND gate 824.

Referring to FIGS. 7 and 8 together, the AND gate 720 generates the AND signal AND_OUT with different states by changing the state of the control signal K outputted from the duplicate sampling circuit 716. According to the state of the AND signal AND_OUT, the D-type flip-flops 802, 804 and 806 can output the corresponding selection instruction φ<0:2> to the phase multiplexer 702 from the positive output terminals Q thereof.

The following will employ a signal time-sequence view of the phase switcher 604, to describe the operation of the phase switcher 604.

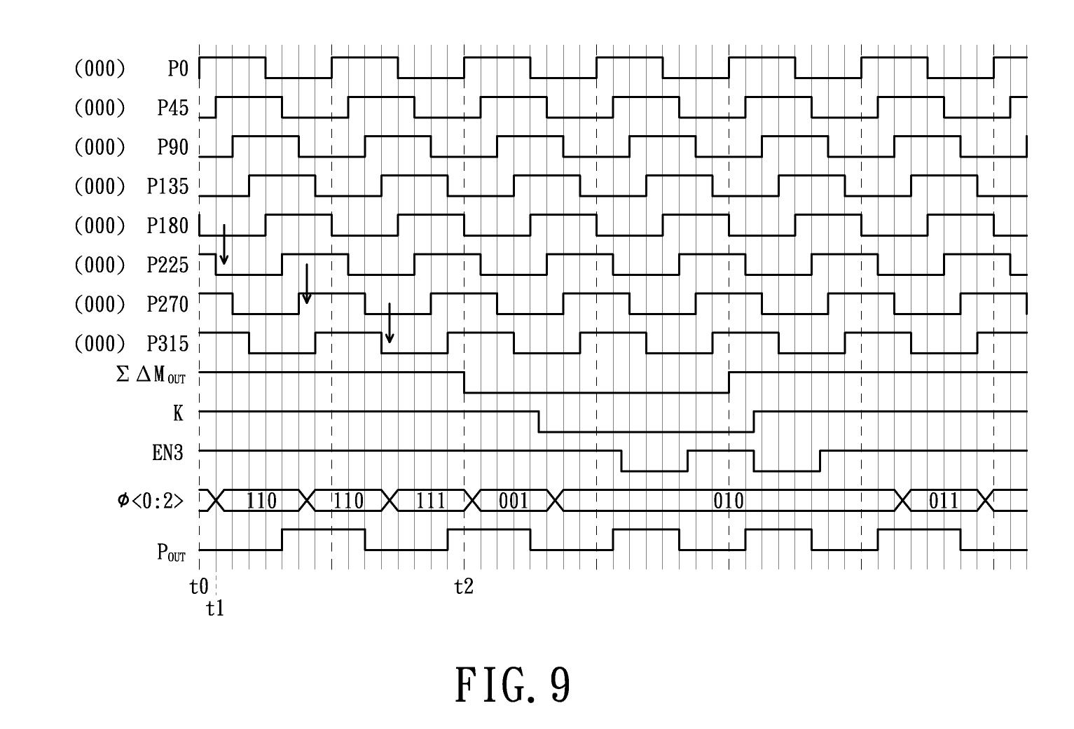

FIG. 9 is a signal time-sequence view of a phase switcher 604 in accordance with an exemplary embodiment of the present invention. Referring to FIGS. 7, 8 and 9 together, in the signal time-sequence view as shown in FIGS. 9, P0, P45, P90, P135, P180, P225, P270 and P315 are phase signals outputted from the multi-phase locked loop 606. The corresponding selection instruction φ<0:2> are 000_{b}, 001_{b}, 010_{b}, 011_{b}, 100_{b}, 101_{b}, 110_{b} and 111_{b} respectively. In the exemplary embodiment, the control signal K and the enable signal EN3 are both in the logic 1 state at a time t0, and the selection instruction φ<0:2> is 100b at the time t0. Therefore, the phase multiplexer 702 will select the phase signal P180 as the phase output signal P_{OUT}. At the moment, since the phase signal P180 is in the logic 0 state, the phase output signal P_{OUT} is also in the logic 0 state.

Then, the clock signal CLK is enabled at a time t1. Since the positive output terminal Q of the D-type flip-flop 802 is in the logic 0 state at the time t0, the XOR gate 812 will output the logic 1 at the time t1, such that the positive output terminal Q of the D-type flip-flop 802 is in the logic 1 state at the time t1. In addition, the AND gate 822 outputs the logic 0 at the time t1, such that the output of the XOR gate 814 and the AND gate 824 are both in the logic 0 state. Therefore, the positive output terminal Q of the D-type flip-flop 804 is still in the logic 0 state. In addition, the output of the XOR gate 816 is in the logic 1 state, thus the positive output terminal Q of the D-type flip-flop 806 is still in the logic 1 state. From the above it can been seen that, the selection instruction φ<0:2> is 101 at the time t1. Therefore, the phase multiplexer 702 will select the phase signal P225 as the phase output signal P_{OUT} at the time t1. Since the phase signal P225 is also in the logic 0 state at the time t1, the phase output signal P_{OUT} will be still in the logic 0 state to perform the seamless switching function.

In addition, the clock signal CLK is enabled again at a time t2. The previous selection instruction φ<0:2> is 111, that is the positive output terminals Q of the D-type flip-flops 802, 804 and 806 are all in the logic 1 state before the time t2. Therefore, the output of the XOR gate 812 is switched to be in the logic 0 state, and the output of the AND gate 822 is in the logic 1 state. Therefore, the positive output terminal Q of the D-type flip-flop 802 is in the logic 0 state at the time t2. Similarly, the output of the XOR gate 814 and the AND gate 824 are be in the logic 0 state and the logic 1 state respectively, thus the positive output terminal Q of the D-type flip-flop 804 is in the logic 0 state at the time t2. In addition, the first input terminal and the second input terminal of the XOR gate 816 are both in the logic 1 state, thus the output terminal thereof will be in the logic 0 state, such that the positive output terminal Q of the D-type flip-flop 806 is in the logic 0 state at the time t2. From the above it can be seen that, the selection instruction φ<0:2> at the time t2 is 000. Therefore, the phase multiplexer 702 will select the phase signal P0 as the phase output signal P_{OUT}. The phase multiplexer 702 can go back and forth continuously to select the phase signals P0, P45, P90, P135, P180, P225, P270 and P315 as the phase output signal POUT in a sequence to perform the seamless switching function.

In summary, the present invention can achieve the following advantageous.

Firstly, the present invention employs the LP filter and the sigma-delta modulator to eliminate the noise with the high frequency and the noise with the low frequency, thus it can improve the quality of the feedback signal.

Secondarily, the present invention employs the digital control oscillator to generate the feedback signal, thus the feedback signal is not prone to be influenced by the manufacturing processes.

Thirdly, the present invention directly employs the mixer to replace the phase frequency detector and the mixer of the prior art, thus it can reduce the size of the receiver and decrease the cost of the hardware.

While the invention has been described in terms of what is presently considered to be the most practical and preferred embodiments, it is to be understood that the invention needs not be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. A receiver, suitable for receiving a GFSK signal and generating a digital output data, comprises:
an input-stage circuit, having a mixer for mixing the GFSK signal with a feedback signal to generate an input-stage current signal;
a filter circuit, coupled to the input-stage circuit, for converting the input-stage current signal into a voltage signal;
an output-stage circuit, coupled to the filter circuit, for converting the voltage signal into the digital output data; and
a digital control oscillator, coupled to the output-stage circuit, for outputting the feedback signal based on the digital output data.

2. The receiver according to claim 1, wherein the input-stage circuit comprises:
an antenna, receiving the GFSK signal; and
an amplifier, coupled to the antenna and the mixer, for amplifying the GFSK signal and sending the amplified GFSK signal to the mixer.

3. The receiver according to claim 1, wherein the filter circuit comprises:
a first adder, coupled to the input-stage circuit, for adding the input-stage current signal with a feedback current signal to generate a mixing current signal;
a current generator, coupled to the output-stage circuit and the first adder, for generating the feedback current signal based on the digital output data; and
a low-pass (LP) filter, coupled to the first adder, for filtering the mixing current signal and generating the voltage signal.

4. The receiver according to claim 1, wherein the output-stage circuit comprises a quantizer, coupled to the filter circuit, for generating a thermometer code based on the voltage signal to generate the digital output data.

5. The receiver according to claim 4, wherein the output-stage circuit further comprises:
a TB converter, coupled to the quantizer, for converting the thermometer code into a binary-bit code as the digital output data; and
a second adder, adding the binary-bit code with a predetermined value to generate a sum data to the digital control oscillator.

6. The receiver according to claim 1, wherein the digital control oscillator comprises:
a modulator, coupled to the output-stage circuit, for generating a modulation signal based on the digital output data;
a multi-phase locked loop, for outputting a plurality of phase signals; and
a phase switcher, coupled to the modulator and the multi-phase locked loop, for generating the feedback signal based on the phase signals and the modulation signal.

7. The receiver according to claim 6, wherein the digital control oscillator further comprises a divider, coupled to the multi-phase locked loop, for generating a first enable signal based on an output of the multi-phase locked loop, and sending the first enable signal to the modulator and the output-stage circuit.

8. The receiver according to claim 6, wherein the phase switcher comprises:
a phase multiplexer, coupled to the multi-phase locked loop, for selecting one of the phase signals based on a selection instruction, so as to generate the feedback signal; and
a phase controller, coupled to the phase multiplexer and the modulator, for generating the selection instruction according to an output of the phase multiplexer and the modulation signal.

9. The receiver according to claim 8, wherein the phase controller comprises:
a delayer, coupled to the phase multiplexer, for delaying a selected phase signal by a predetermined time, and outputting a delayed phase signal;
a first Exclusive-OR (XOR) gate, coupled to the phase multiplexer and the delayer, for outputting a first XOR gate signal based on the selected phase signal and the delayed phase signal;
a duplicate sampling circuit, coupled to the first modulator and the XOR gate, for outputting a sampling control signal based on the modulation signal and the first XOR gate signal;
a first AND gate, for outputting a first AND gate signal based on the sampling control signal and a second enable signal; and
a phase-state accumulator, coupled to the first AND gate and the first XOR gate, for generating the selection instruction to the phase multiplexer based on the first XOR gate signal and the first AND gate signal.

10. The receiver according to claim 9, wherein the phase-state accumulator comprises:
a first D-type flip-flop, a second D-type flip-flop and a third D-type flip-flop, each thereof having an enable terminal, an input terminal and a positive output terminal, all of enable terminals of the first, second and third D-type flip flops being coupled to a clock signal, and positive output terminals thereof being configured for outputting the selection instruction;
a second XOR gate, having a first input terminal and an output terminal coupled to the positive output terminal and the input terminal of the first D-type flip-flop respectively, and a second input terminal coupled to the first AND gate for receiving the first AND gate signal;
a second AND gate, having a first input terminal and a second input terminal coupled to the first and the second input terminals of the second XOR gate respectively;
a third XOR gate, having a first input terminal coupled to the positive terminal of the second D-type flip-flop, an output terminal coupled to the input terminal of the second D-type flip-flop, and a second input terminal coupled to the output terminal of the second AND gate respectively;
a third AND gate, having a first input terminal and a second input terminal coupled to the first and the second input terminals of the third XOR gate respectively; and
a fourth XOR gate, having a first input terminal coupled to the positive output terminal of the third D-type flip-flop, an output terminal coupled to the input terminal of the third D-type flip-flop, and a second input terminal coupled to the output terminal of the third AND gate respectively.
